(19) United States
(12) Patent Application Publication
(10) Pub. No.: US 2013/0052547 A1
(43) Pub. Date: Feb. 28, 2013

(54) POWER STORAGE DEVICE AND METHOD OF MANUFACTURING POWER STORAGE DEVICE

(71) Applicants: Kiyofumi OGINO, Isehara (JP); Yumiko Saito, Atsugi (JP)

(72) Inventors: Kiyofumi OGINO, Isehara (JP); Yumiko Saito, Atsugi (JP)

(73) Assignee: SEMICONDUCTOR ENERGY LABORATORY CO., LTD., Atsugi-shi (JP)

(21) Appl. No.: 13/586,905

(22) Filed: Aug. 16, 2012

(30) Foreign Application Priority Data
Aug. 31, 2011 (JP) 2011-189289

(51) Int. Cl. H01M 12/08; H01M 6/00; H01M 4/96; H01M 4/42; B82Y 30/00

(52) U.S. Cl. 429/406; 429/403; 429/405; 29/623.1; 977/734

(57) ABSTRACT

A structure and a method of manufacturing a power storage device with high energy density are provided. An air electrode includes a first current collector; a second current collector having a projecting structure, in contact with the first current collector; and a catalyst layer having 1 to 100 graphene films. Accordingly, the surface area of the air electrode can be significantly large due to an effect of the second current collector, and further, the graphene film can produce a catalytic reaction without using a catalyst such as a noble metal; thus, by employing a structure in which the catalyst layer is provided on the second current collector, the energy density of the power storage device can be improved.

### BACKGROUND OF THE INVENTION

1. Field of the Invention

The present invention relates to a power storage device and a method of manufacturing the power storage device.

2. Description of the Related Art

As a power storage device used for consumer electronic devices and the like, a secondary battery such as a nickel metal hydride battery or a lithium ion battery has been widely used; however, in recent years, application of a secondary battery as a power storage device for home use and a power source for a car has been significantly increased, so that commercial secondary batteries with higher energy density are required.

Thus, a power storage device including a metal electrode and an air electrode and having much higher theoretical energy density than the above secondary battery has been actively researched (for example, see Patent Document 1).

### REFERENCE

### Patent Document

[Patent Document 1] Japanese Published Patent Application No. 2011-96492

### SUMMARY OF THE INVENTION

In view of the foregoing background, in this specification, an object is to provide a power storage device with high energy density. Another object is to provide a method of manufacturing the power storage device.

One embodiment of the present invention is a power storage device including a metal anode; an air electrode; and an electrolyte solution filling a space between the metal anode and the air electrode. The air electrode includes a first current collector; a second current collector having a plurality of projecting structures, in contact with the first current collector; and a catalyst layer on the second current collector. The catalyst layer includes 1 or more and 100 or less graphene films.

According to the above embodiment of the present invention, the surface area of the air electrode (that is, the surface area of the catalyst layer) can be significantly large. Note that the graphene film used as the catalyst layer can produce alone a catalytic reaction without using a catalyst such as a noble metal or a metal oxide, and the graphene film can be formed uniformly with an extremely small thickness on a surface of a structure having projections and depressions by an electrophoresis method or the like. Accordingly, a power storage device with high energy density can be provided.

In the above power storage device, in the case where the metal anode is formed using a metal, an alloy, or a compound containing aluminum, zinc, or iron, which has low reactivity with respect to water, as its main component, an aqueous electrolyte solution may be used as the electrolyte solution.

In the above power storage device, in the case where the metal anode is formed using a metal, an alloy, or a compound containing lithium, calcium, sodium, or magnesium, which has high reactivity with respect to water, as its main component, an organic electrolyte solution may be used as the electrolyte solution.

Another embodiment of the present invention is a power storage device including a lithium anode; an air electrode; a solid electrolyte positioned between the lithium anode and the air electrode; an organic electrolyte solution filling a space between the lithium anode and the solid electrolyte; and an aqueous electrolyte solution filling a space between the air electrode and the solid electrolyte. The solid electrolyte selectively transmits only a lithium ion released from the lithium anode. The air electrode includes a first current collector; a second current collector having a plurality of projecting structures, in contact with the first current collector; and a catalyst layer on the second current collector. The catalyst layer includes 1 or more and 100 or less graphene films.

According to the above embodiment of the present invention, the surface area of the air electrode can be significantly large. After lithium ions released from the lithium anode pass through the solid electrolyte to reach the aqueous electrolyte solution, the lithium ions in the vicinity of the solid electrolyte react with hydroxide ions which are released from the air electrode; thus, water-soluble lithium hydroxide is produced. For this reason, unlike in the case of a general metal-air battery, deposition of a solid reaction product onto the surface of the air electrode can be prevented. Accordingly, a power storage device which has high energy density and in which deterioration due to a reaction is prevented can be provided.

In the above power storage device, the first current collector is preferably formed using a porous or mesh conductive material because a gas containing oxygen (e.g., air) which is introduced from the outside is not prevented from reaching the catalyst layer by the first current collector or is less likely to be prevented from reaching the catalyst layer by the first current collector.

In the above power storage device, a plurality of whisker-like structures (hereinafter, simply referred to as whiskers) containing silicon as its main component may be used as the projecting structures. The length of the whiskers can be extremely long; thus, the surface area of the air electrode can be larger. Accordingly, a power storage device with higher energy density can be provided.

When a plurality of projections each having a height of 100 nm or less is provided on the surfaces of the whiskers, the surface area of the air electrode can be larger. Accordingly, a power storage device with higher energy density can be provided.

Another embodiment of the present invention is a method of manufacturing a power storage device, including the steps of forming a second current collector having a plurality of projecting structures over a first current collector; and forming an electrode including a catalyst layer including 1 or more and 100 or less graphene films, on the second current collector. The electrode is used as an air electrode.

The use of a manufacturing method according to the above embodiment of the present invention enables the surface area of the air electrode (that is, the surface area of the catalyst layer) to be significantly large. Note that the graphene film used as the catalyst layer can produce alone a catalytic reaction without using a catalyst such as a noble metal or a metal oxide, and the graphene film can be formed uniformly with an extremely small thickness on a surface of a structure having projections and depressions by an electrophoresis method or the like. Accordingly, a power storage device with high energy density can be manufactured.

In the above method of manufacturing a power storage device, the first current collector is preferably formed using a porous or mesh conductive material because a gas containing oxygen (e.g., air) which is introduced from the outside is not prevented from reaching the catalyst layer by the first current collector or is less likely to be prevented from reaching the catalyst layer by the first current collector.

In the above method of manufacturing a power storage device, a plurality of whisker-like structures containing silicon as its main component may be used as the projecting structures. The length of the whiskers can be extremely long; thus, the surface area of the air electrode can be larger. Accordingly, the energy density of a power storage device can be higher.

With the use of the whiskers whose surfaces have a plurality of projections each having a height of 100 nm or less, the surface area of the air electrode can be larger. Accordingly, the energy density of the power storage device can be higher.

In this specification, single-layer graphene and multilayer graphene are collectively referred to as graphene in some cases.

In this specification, a main component refers to an element included in composition at 5 atomic % or more.

As described above, the air electrode includes the first current collector; the second current collector having a plurality of projecting structures, in contact with the first current collector; and the catalyst layer on the second current collector; thus, the surface area of the air electrode can be significantly large. Accordingly, a power storage device with high energy density can be provided.

### BRIEF DESCRIPTION OF THE DRAWINGS

FIGS. 1A and 1B illustrate a structure of a power storage device.

FIGS. 2A to 2C illustrate air electrodes of a power storage device.

FIGS. 3A to 3C illustrate air electrodes of a power storage device.

FIGS. 4A to 4D illustrate a method of manufacturing a power storage device.

FIG. 5 illustrates a method of forming whiskers.

FIG. 6 illustrates a structure of a power storage device.

FIGS. 7A and 7B illustrate examples of a device including a power storage device.

FIGS. 8A and 8B show whiskers.

FIG. 9 shows whiskers.

FIGS. 10A and 10B show a whisker.

### DETAILED DESCRIPTION OF THE INVENTION

Embodiments and examples of the present invention will be described in detail with reference to the accompanying drawings. Note that the present invention is not limited to the following description, and it will be easily understood by those skilled in the art that various changes and modifications can be made without departing from the spirit and scope of the present invention. Therefore, the present invention should not be construed as being limited to the description in the following embodiments and examples. Note that in structures of the present invention described below, the same portions or portions having similar functions are denoted by the same reference numerals in different drawings, and description thereof is not repeated.

### Embodiment 1

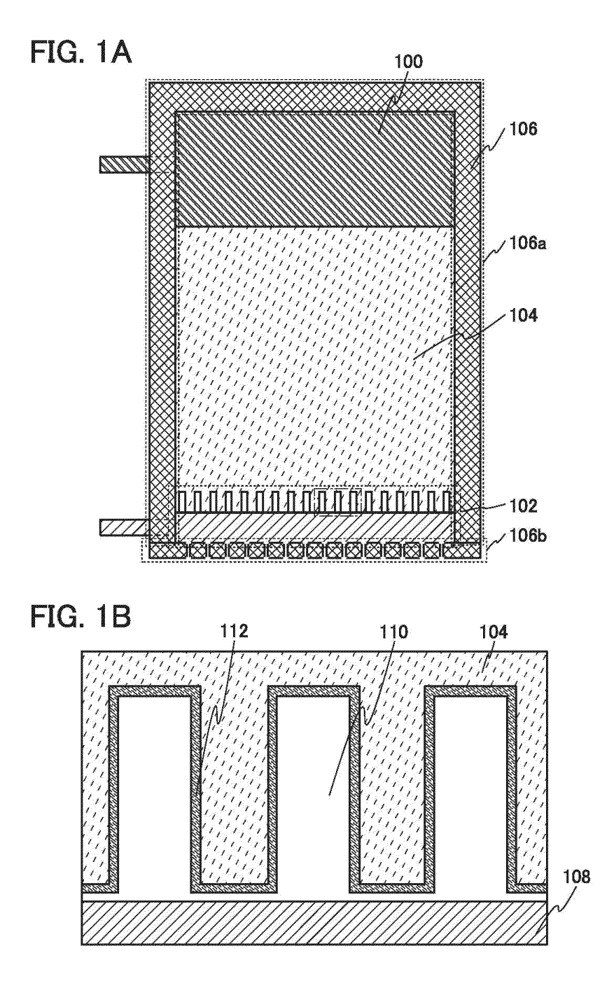

In this embodiment, an example of a structure and a method of manufacturing a power storage device according to one embodiment of the present invention will be described with reference to FIGS. 1A and 1B, FIGS. 2A to 2C, FIGS. 3A to 3C, FIGS. 4A to 4D, and FIG. 5.

### Structure of Power Storage Device of Embodiment 1

FIG. 1A is a cross-sectional structural view of a power storage device of this embodiment. As illustrated in FIG. 1A, a metal anode 100 and an air electrode 102 are provided in a housing 106, and a space between the metal anode 100 and the air electrode 102 is filled with an electrolyte solution 104. Note that as illustrated in FIG. 1B (an enlarged view of a region surrounded by a dashed-dotted line in FIG. 1A), the air electrode 102 has the following structure: a second current collector 110 having projecting structures is formed on a surface of a first current collector 108, and a surface of the second current collector 110 which is covered with a catalyst layer 112 is in contact with the electrolyte solution 104.

Note that a material used for the metal anode 100 is selected as appropriate depending on a material used for the electrolyte solution 104. The housing 106 can be divided into a housing 106a on the anode side and a housing 106b on the air electrode side.

In the case where an organic electrolyte solution (also referred to as nonaqueous electrolyte solution or the like) is used as the electrolyte solution 104, a metal, an alloy, or a compound containing lithium, calcium, sodium, or magnesium, which has high ionization tendency, as its main component can be used as the metal anode 100. In the case of forming the electrolyte solution 104 and the metal anode 100 using the above respective materials, there are advantages in that the rated voltage is high (the decomposition voltage is high as compared to the case of using an aqueous electrolyte solution) and the energy density is high.

In the case where an aqueous electrolyte solution is used as the electrolyte solution 104, a metal, an alloy, or a compound containing aluminum, zinc, or iron, which has low reactivity with respect to water, as its main component can be used as the metal anode 100. In the case of forming the electrolyte solution 104 and the metal anode 100 using the above respective materials, there are advantages in that the degree of safety is high due to nonvolatility of the electrolyte solution 104 and the cost of the electrolyte solution 104 is low.

There is no particular limitation on the material of the electrolyte solution 104, and a known electrolyte solution used for a power storage device may be employed depending on the kind of material of the metal anode 100. Further, as the electrolyte solution 104, an ionic liquid may also be used. An ionic liquid is stable because it has low volatility and low inflammability at room temperature and is in a liquid state over a wide temperature range; thus, an ionic liquid has desirable characteristics for the electrolyte solution 104.

As illustrated in FIG. 1B, the air electrode 102 includes the first current collector 108; the second current collector 110 having projecting structures, in contact with the first current collector 108; and the catalyst layer 112 on the second current collector 110. The catalyst layer 112 is in contact with the electrolyte solution 104. Although the catalyst layer 112 covers the entire upper surface of the second current collector 110 in FIG. 1B, the catalyst layer 112 may cover part thereof.

The first current collector 108 needs to have a structure that does not prevent oxygen from reaching a surface of the air electrode 102 (that is, a surface in contact with the electrolyte solution 104) as much as possible. Therefore, the first current collector 108 preferably has a structure partly including an opening, like a porous structure or a mesh structure, for example.

The first current collector 108 can be formed using a metal material typified by platinum, aluminum, copper, or titanium. The first current collector 108 may also be formed using an aluminum alloy to which an element improving heat resistance, such as silicon, titanium, neodymium, scandium, or molybdenum, is added.

When the size of the opening in the first current collector 108 is too small, oxygen supply might be inhibited; when it is too large, the formation of the second current collector 110 might be difficult. In view of this, the size of the opening is preferably greater than or equal to 1 nm² and less than or equal to 50 μm², more preferably greater than or equal to 10 nm² and less than or equal to 10 μm². The aperture ratio of a surface of the first current collector 108 is preferably 10% or higher, more preferably 30% or higher, still more preferably 50% or higher.

The second current collector 110 has a plurality of projecting structures on the side in contact with the electrolyte solution 104 as illustrated in FIGS. 1A and 1B. With these projecting structures, the surface area of the air electrode 102 (that is, the area of a region where the catalyst layer 112 and the electrolyte solution 104 are in contact with each other) can be made larger.

As the second current collector 110, for example, silicon can be used. As the projecting structures, whiskers may be used. In the case where whiskers are used as the projecting structures, silicon is preferably contained as a main component, and vapor phase growth on the first current collector 108 can be performed by an LPCVD method (for the details of the method of forming the whiskers, refer to Example 1).

The whiskers are formed by causing crystal growth of a semiconductor material or a metal so that it has a columnar or needle-like protrusion. In the case where the projecting structures of the second current collector 110 are whiskers, there is no particular limitation on the number of whiskers. However, in terms of an effect of increasing the surface area of the air electrode 102, the preferable density of whiskers in a portion where the whiskers are formed is as follows: five or more whiskers per 100 μm², more preferably, 10 or more whiskers per 100 μm². Note that the whiskers may have a columnar shape such as a cylinder shape or a prism shape, a needle-like shape such as a cone or a pyramid, or may be curved toward a tip thereof.

Although there is also no particular limitation on the length of the whiskers, the whiskers can be formed so as to have an extremely long length depending on its formation conditions (for the details of the shape of the whiskers, refer to Example 1). In terms of the effect of increasing the surface area of the air electrode 102, each of the whiskers preferably has a length of 1 μm or more, more preferably 5 μm or more, still more preferably 10 μm or more. With such a length, the surface area of the air electrode can be significantly large. Accordingly, a power storage device with high energy density can be manufactured.

Further, a plurality of projections with an extremely small size (specifically, with a height (length) of 100 nm or less, preferably a height of 50 nm or less) can be provided on the surfaces of the whiskers depending on the formation conditions of the whiskers (for the details of the shape of the whiskers, refer to Example 1). The use of the whiskers having a plurality of projections with an extremely small size for the second current collector 110 in such a manner enables the surface area of the air electrode to be larger.

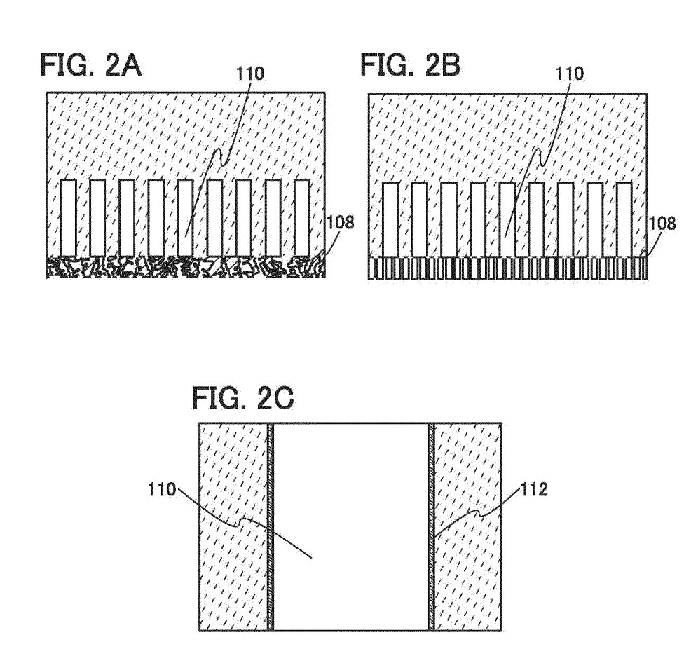

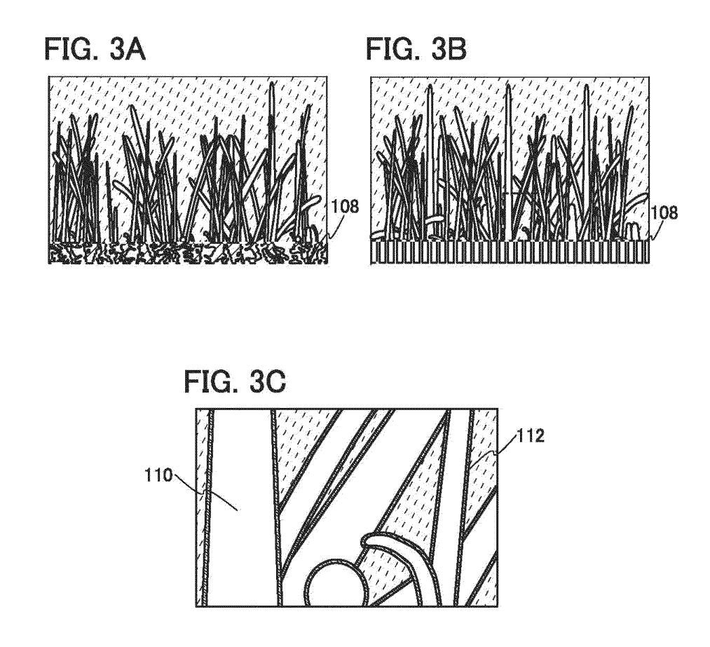

Here, examples of structures of the first current collector 108 and the second current collector 110 are described with reference to FIGS. 2A to 2C and FIGS. 3A to 3C.

FIG. 2A is a schematic cross-sectional view in which the second current collector 110 having columnar structures as the projecting structures is positioned over the first current collector 108 having a porous structure, and in which the catalyst layer 112 is positioned so as to cover the second current collector 110 as illustrated in FIG. 2C. FIG. 2B is a schematic cross-sectional view in which the second current collector 110 having columnar structures as the projecting structures is positioned over the first current collector 108 having a mesh structure, and in which the catalyst layer 112 is positioned so as to cover the second current collector 110 as illustrated in FIG. 2C. A gas containing oxygen (e.g., air) which is introduced through the first current collector 108 from the outside reaches the surface of the air electrode 102 through porous portions (also referred to as openings) of the first current collector 108. Note that the columnar structures may be island-shaped structures separate from each other, a linear structure, a lattice-shaped structure, or a honeycomb-like structure, for example.

When the columnar structures are formed over the openings of the first current collector 108, the amount of gas introduced from the outside is reduced. Therefore, in the case where the area of the openings formed on the surface of the first current collector 108 is defined as 1, the second current collector 110 is preferably formed so that the area of the openings that are not blocked after the formation of the second current collector 110 is 0.3 or more, more preferably 0.5 or more.

Although the taper angle of the columnar structures is 90° in FIGS. 1A and 1B and FIGS. 2A to 2C, there is no particular limitation on the shapes of the projecting structures; they may have a variety of shapes such as a shape whose cross section becomes narrower toward the top, a cylindrical shape, and a conical shape.

FIG. 3A is a schematic cross-sectional view in which the second current collector 110 having whiskers as the projecting structures is positioned over the first current collector 108 having a porous structure, and in which the catalyst layer 112 is positioned so as to cover the second current collector 110 as illustrated in FIG. 3C. FIG. 3B is a schematic cross-sectional view in which the second current collector 110 having whiskers as the projecting structures is positioned over the first current collector 108 having a mesh structure, and in which the catalyst layer 112 is positioned so as to cover the second current collector 110 as illustrated in FIG. 3C. A gas containing oxygen (e.g., air) which is introduced through the first current collector 108 from the outside reaches the surface of the air electrode 102 through porous portions of the first current collector 108.

Growth of the whiskers can selectively start from portions where the first current collector 108 is provided (that is, portions of the first current collector 108, except the openings) (for a specific method of forming the whiskers, refer to Example 1). For that reason, unlike in the case of the columnar structures, the openings are less likely to be directly covered (that is, the whiskers are less likely to be formed directly over the openings). Therefore, the surface area of the air electrode can be significantly large, and a gas containing oxygen (e.g., air) can be efficiently introduced from the outside.

The catalyst layer 112 is provided on the second current collector 110, so that the catalyst layer 112 is formed in an extremely wide area. The catalyst layer 112 may have 1 to 100 graphene films. The graphene film alone can produce a catalytic reaction without using a catalyst such as a noble metal or a metal oxide, and the graphene film can be formed uniformly with an extremely small thickness on the surfaces of the structures having projections and depressions by an electrophoresis method or the like. Accordingly, a power storage device with high energy density can be provided.

Since a catalyst such as a noble metal or a metal oxide is not used, it is possible to improve the throughput and reduce the cost in manufacture of the power storage device.

In the power storage device of this embodiment, the above-described metal anode 100, air electrode 102, and electrolyte solution 104 are provided in the housing 106 as illustrated in FIG. 1A.

### Method of Manufacturing Power Storage Device of Embodiment 1

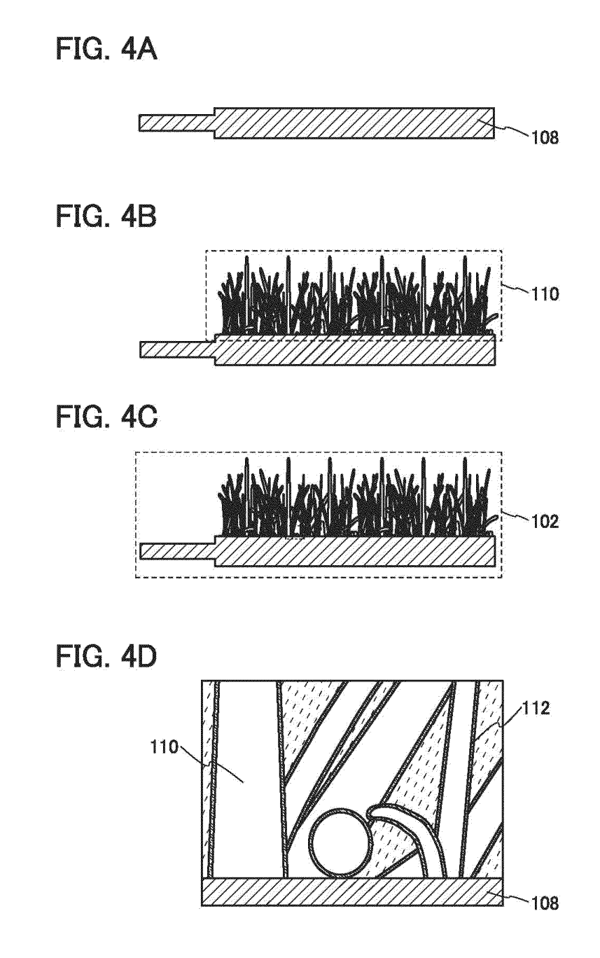

One example of a method of manufacturing the above power storage device of this embodiment will be described with reference to FIGS. 4A to 4D.

First, the first current collector 108 is prepared (see FIG. 4A). The first current collector 108 functions as a terminal for extracting electricity. Although the first current collector 108 can be formed using a variety of materials and a variety of structures as described above, the case where the first current collector 108 is formed using a mesh material containing titanium as its main component is described here. Note that in the first current collector 108, a portion which is not covered with the housing 106 (a portion which functions as an external connection terminal) does not need to be formed using a mesh material.

Next, the first current collector 108 is subjected to surface treatment. For example, the surface treatment may be performed with the use of hydrofluoric acid having a concentration higher than or equal to 0.1% and lower than or equal to 1% for 10 seconds to 1 hour. By the surface treatment, the cleanliness of the surface of the first current collector 108 is improved. Further, the surface becomes rough (that is, minute projections and depressions on the surface become large), and the adhesion with a crystalline semiconductor layer to be formed later can be improved. Since the projections and depressions become large, a so-called anchor effect occurs. Accordingly, depressed portions are filled with a semiconductor material; thus, the adhesion can be improved. After chemical solution cleaning such as hydrofluoric acid treatment is performed, running water cleaning with pure water may be performed. Accordingly, the cleanliness of the surface of the first current collector 108 is further improved.

Next, over the first current collector 108, the second current collector 110 having the projecting structures is formed by a CVD method or a PVD method (see FIG. 4B). The case where a layer having whiskers containing silicon as its main component is formed as the second current collector 110 by an LPCVD method, which is one kind of CVD method, is described here (a specific method of forming whiskers is described in Example 1 in detail). In the case where columnar structures illustrated in FIGS. 2A to 2C are formed, the second current collector 110 may be formed in such a manner that a film functioning as the second current collector 110 is formed by a CVD method or a PVD method and then the film is processed into a desired shape by a photolithography method.

The LPCVD method is performed using a source gas containing silicon while a substrate is heated. Examples of the source gas containing silicon include silicon hydride, silicon fluoride, and silicon chloride; typically, SiH₄, Si₂H₆, SiF₄, SiCl₄, Si₂Cl₆, and the like are given. The heating temperature is set higher than 550° C. and lower than or equal to the temperature that an LPCVD apparatus or the first current collector 108 can withstand, preferably higher than or equal to 580° C. and lower than 650° C. Note that one or more of a rare gas such as helium, neon, argon, or xenon, nitrogen, and hydrogen may be mixed in the source gas. The pressure in a reaction chamber of the LPCVD apparatus is set higher than or equal to the lower limit of the pressure that can be held with the source gas supplied and lower than or equal to 200 Pa.

As described above, by performing surface treatment on the first current collector 108 before the formation of the second current collector 110, the adhesion between the first current collector 108 and the second current collector 110 can be improved. Accordingly, deterioration of the power storage device can be reduced. Further, power storage devices can be manufactured with improved productivity.

When the second current collector 110 is formed by vapor phase growth in the above manner, it is possible to improve the throughput and reduce the cost in manufacture of the power storage device.

Next, the catalyst layer 112 is formed on the second current collector 110. Since the second current collector 110 has projecting structures (here, whiskers), it is difficult to form the catalyst layer 112 uniformly in a large area of the surface of the second current collector 110 by a PVD method; therefore, instead of a PVD method, a CVD method or an electrophoresis method is preferably employed. Here, an electrophoresis method is employed for forming the catalyst layer 112.

As the catalyst layer 112, one graphene film or a plurality of stacked graphene films may be used. In the case where graphene films are stacked, there is a high possibility that a graphene layer is separated from the catalyst layer 112 at the time of charge and/or discharge, because the larger the number of stacked graphene films is, the more likely the films are to be separated from the catalyst layer 112. For that reason, the number of stacked graphene films is preferably 100 or less, more preferably 50 or less, still more preferably 20 or less. Since the graphene film functions as a catalyst without a catalytic material such as a noble metal or a metal oxide added to the graphene film, it is possible to prevent an increase in cost of the power storage device and an increase in manufacturing time due to the use of the catalytic material.

For the formation of the catalyst layer 112, first, graphene oxide is dispersed in a solvent such as water or N-methylpyrrolidone (NMP). The solvent is preferably a polar solvent. The graphene oxide is preferably contained at a concentration of 0.1 g to 10 g per liter.

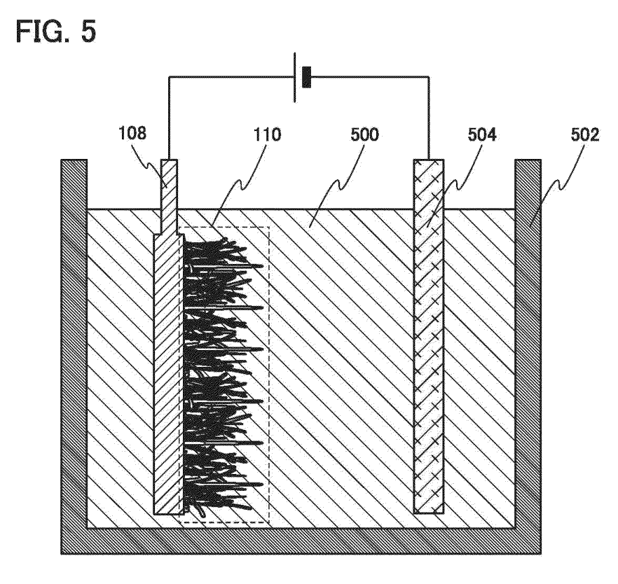

FIG. 5 illustrates an apparatus used in this embodiment. A structure for forming graphene (here, the first current collector 108 whose surface is provided with the second current collector 110) is put in a container 502 filled with a solution 500 in which graphene oxide is dispersed, and this structure is used as an anode. A conductor 504 serving as a cathode is put into the solution, and appropriate voltage (for example, higher than or equal to 5 V and lower than or equal to 20 V) is applied between the cathode and the anode. Note that the voltage is not necessarily constant. By measuring the amount of charge flowing between the cathode and the anode, the thickness of a graphene oxide layer deposited on the structure can be estimated.

When graphene oxide with a required thickness is obtained, the structure is taken out of the solution and dried. Further, the structure is heated at 150° C. or higher, preferably 200° C. or higher in a vacuum or in a reducing atmosphere such as an inert gas (nitrogen, a rare gas, or the like) atmosphere. By being heated at a higher temperature and for a longer time, graphene oxide is reduced to a higher extent, so that graphene with higher purity (i.e., with a lower concentration of elements other than carbon) and higher conductivity can be obtained. The heating temperature and the heating time may be determined by a practitioner as appropriate in consideration of reactivity between the inert gas and the first current collector 108 and between the inert gas and the second current collector 110. Note that it is known that graphene oxide is reduced to graphene at 150° C.

The graphene oxide layer formed on the second current collector 110 is reduced, and a graphene layer corresponding to the catalyst layer 112 is formed so as to cover the second current collector 110 provided over the first current collector 108 as illustrated in FIGS. 4C and 4D (FIG. 4D is an enlarged view of part of the surface of the first current collector 108 in FIG. 4C); in this manner, the air electrode 102 is formed. At that time, adjacent graphenes are bonded to each other to form a huge net-like or sheet-like network. Even when the structure has projections and depressions, the thus formed graphene layer has a substantially uniform thickness at the projections and depressions. Note that specific examples of a method of forming the catalyst layer 112 and a structure thereof will be described in Example 1.

There is no particular limitation on the shape and material of the housing 106; for the housing 106, a material that is not corroded or melted by the electrolyte solution with which the inside of the housing 106 is filled may be used.

The metal anode 100, the electrolyte solution 104, and the air electrode 102 are sequentially placed in the housing 106a on the anode side, and lastly, the housing 106a on the anode side is sealed with the housing 106b on the air electrode side; in such a manner, the power storage device of this embodiment is completed. Note that the electrolyte solution 104 may be injected, in a liquid state, in the housing 106a on the anode side, or may be placed in the housing 106a on the anode side in the state where a separator is impregnated with the electrolyte solution 104.

Note that an oxygen-transmitting film may be provided between the housing 106 and the air electrode 102, which enables oxygen in a gas introduced from the outside (e.g., air) to be selectively transmitted and substances other than oxygen (e.g., moisture) not to be introduced into the inside of the power storage device; thus, the reliability and durability of the power storage device can be improved.

The metal anode 100 may be formed using a solid material (e.g., lithium rod) including a metal, an alloy, or a compound containing lithium, calcium, sodium, magnesium, aluminum, zinc, or iron as its main component.

In the case where the metal anode 100 is formed using a metal, an alloy, or a compound containing aluminum, zinc, or iron, which has low reactivity with respect to water, as its main component, the electrolyte solution 104 may be an aqueous electrolyte solution. Note that a known material may be used as an aqueous electrolyte solution.

In the case where the metal anode 100 is formed using a metal, an alloy, or a compound containing lithium, calcium, sodium, or magnesium, which has high reactivity with respect to water, as its main component, the electrolyte solution 104 may be an organic electrolyte solution (nonaqueous electrolyte solution). Note that a known material may be used as an organic electrolyte solution.

Note that there is no particular limitation on a method of placing the metal anode 100, a method of placing the air electrode 102, a method of injecting the electrolyte solution 104, and a method of sealing the housing 106, and known methods may be employed for those methods.

The above is a method of manufacturing a power storage device of this embodiment.

### Embodiment 2

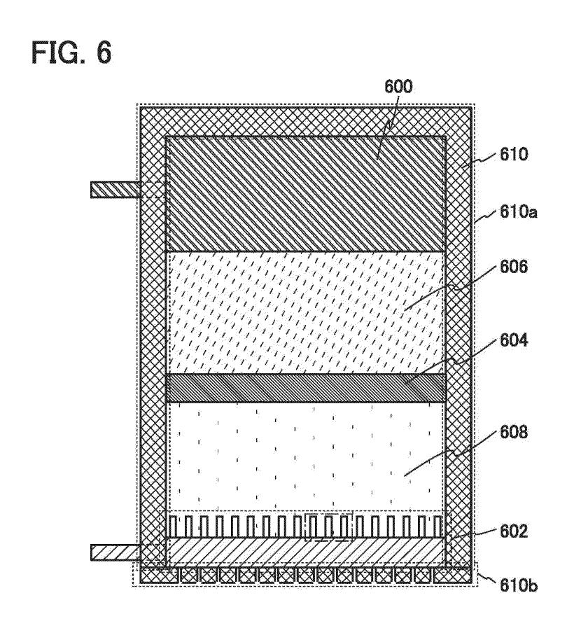

In this embodiment, examples of a structure and a method of manufacturing a power storage device whose structure is different from that of the power storage device described in Embodiment 1 will be described with reference to FIG. 6.

### Structure and Method of Manufacturing Power Storage Device of Embodiment 2

FIG. 6 illustrates a structure of a power storage device of this embodiment, in which a lithium anode 600, an air electrode 602, and a solid electrolyte 604 are provided in a housing 610, a space between the lithium anode 600 and the solid electrolyte 604 is filled with an organic electrolyte solution 606, and a space between the air electrode 602 and the solid electrolyte 604 is filled with an aqueous electrolyte solution 608. The housing 610 can be divided into a housing 610a on the anode side and a housing 610b on the air electrode side.

The structure of this embodiment is different from that of Embodiment 1 in that the solid electrolyte 604 is provided between the lithium anode 600 and the air electrode 602, the space between the solid electrolyte 604 and the lithium anode 600 is filled with the organic electrolyte solution 606, and the space between the solid electrolyte 604 and the air electrode 602 is filled with the aqueous electrolyte solution 608.

The lithium anode 600 may be formed using a metal, an alloy, or a compound containing lithium as its main component. The air electrode 602 has the same structure as the air electrode 102 described in Embodiment 1, and may be formed using the same material and method as the air electrode 102. In addition, the housing 610 may have the same structure as the housing 106 described in Embodiment 1.

The solid electrolyte 604 may be formed using any of known materials through which only lithium ions are transmitted (e.g., known materials described in Japanese Published Patent Application No. 2006-86102 and Japanese Published Patent Application No. 2008-21416), for example, in the case where the lithium anode 600 is formed using a lithium metal.

There is no particular limitation on the organic electrolyte solution 606, and a known organic electrolyte solution may be used therefor. The aqueous electrolyte solution 608 may also be formed using a known aqueous electrolyte solution.

The lithium anode 600, the organic electrolyte solution 606, the solid electrolyte 604, the aqueous electrolyte solution 608, and the air electrode 602 are sequentially placed in the housing 610a on the anode side, and lastly, the housing 610a on the anode side is sealed with the housing 610b on the air electrode side; in such a manner, the power storage device of this embodiment is completed. Note that the organic electrolyte solution 606 and the aqueous electrolyte solution 608 may be injected, in a liquid state, in the housing 610a on the anode side, or may be placed in the housing 610a on the anode side in the state where a separator is impregnated with the organic electrolyte solution 606 and the aqueous electrolyte solution 608.

Note that an oxygen-transmitting film may be provided between the housing 610 and the air electrode 602, which enables oxygen in a gas introduced from the outside (e.g., air) to be selectively transmitted and substances other than oxygen (e.g., moisture) not to be introduced into the inside of the power storage device; thus, the reliability and durability of the power storage device can be improved.

Through the above steps, the power storage device of this embodiment is completed.

Advantages of the power storage device of this embodiment will be briefly described below.

In the case where a power storage device is used for an electric vehicle or the like, high energy density is needed for ensuring high mileage. As described in Embodiment 1, in order to improve the energy density of a power storage device, an organic electrolyte solution is generally used as an electrolyte solution.

However, when an organic electrolyte solution (nonaqueous electrolyte solution) is used as the electrolyte solution, a problem arises in that a solid reaction product such as lithium oxide (Li₂O) or lithium peroxide (Li₂O₂) is deposited onto a surface of the air electrode 602 so that the reaction at the air electrode 602 is prevented. This is because, in the vicinity of the surface of the air electrode 602, lithium ions transferred from the lithium anode react with oxygen introduced from the outside and electrons supplied through the current collector.

In view of this, as in this embodiment, the solid electrolyte 604 through which only lithium ions are transmitted is provided between the lithium anode 600 and the air electrode 602, and then, the space between the lithium anode 600 and the solid electrolyte 604 is filled with the organic electrolyte solution 606 and the space between the air electrode 602 and the solid electrolyte 604 is filled with the aqueous electrolyte solution 608. The mobility of lithium ions released from the lithium anode 600 is extremely low in the aqueous electrolyte solution 608, and thus lithium ions are present in the vicinity of the interface between the solid electrolyte 604 and the aqueous electrolyte solution 608.

At the air electrode 602, oxygen (O₂) introduced from the outside, electrons (e) supplied through the current collector, and water (H₂O) in the aqueous electrolyte solution 608 react with each other so that hydroxide ions (OH) are produced. The hydroxide ions are transferred through the aqueous electrolyte solution and react with lithium ions so that lithium hydroxide (LiOH) is produced. Lithium hydroxide is soluble in water, and is formed in a region away from the air electrode 602; thus, deposition of a solid reaction product onto the surface of the air electrode 602 can be prevented.

Further, since the air electrode 602 of this embodiment has the same structure as the air electrode 102 of Embodiment 1, the surface area of the air electrode 602 is significantly large; thus, with the use of the structure described in this embodiment for a power storage device, the energy density can be significantly improved.

### Embodiment 3

The power storage device described in this specification can be used for power sources of a variety of products which are driven with power. In this embodiment, such products will be described.

Specific examples of products each including the power storage device described in this specification are as follows: display devices, lighting devices, desktop personal computers and laptop personal computers, image reproduction devices which reproduce still images and moving images stored in recording media such as digital versatile discs (DVDs), mobile phones, portable game machines, portable information terminals, e-book readers, video cameras, digital still cameras, high-frequency heating appliances such as microwave ovens, electric rice cookers, electric washing machines, air-conditioning systems such as air conditioners, electric refrigerators, electric freezers, electric refrigerator-freezers, freezers for preserving DNA, and dialyzers. In addition, moving objects driven by electric motors using power from power storage devices are also examples of such products. Examples of the moving objects include electric vehicles, hybrid vehicles each including both an internal-combustion engine and an electric motor, and motorized bicycles including motor-assisted bicycles.

In the products described in this embodiment, the power storage device according to one embodiment of the present invention can be used as a power storage device for supplying enough power for almost the whole power consumption (such a power storage device is referred to as main power source). When power supply from a main power source is stopped, the power storage device provided in the product can also be used as an emergency power source supplying power to the product. Further, the power storage device according to one embodiment of the present invention can be used to supply power to an electric device while the electric device is also supplied with power from the main power supply or a commercial power supply.

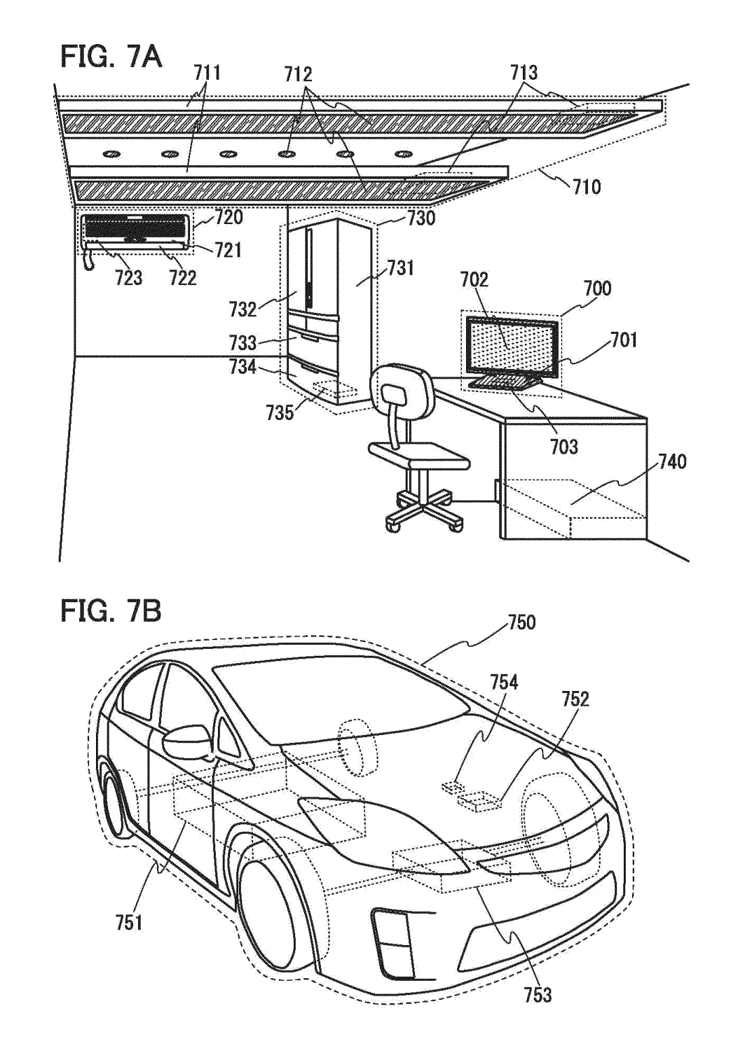

FIG. 7A illustrates a room furnished with a variety of electric devices. In FIG. 7A, a display device 700 corresponds to a desktop personal computer, and includes a housing 701, a display portion 702, a power storage device 703, and the like. The housing 701 is provided with a speaker, various switches (e.g., a power switch), and the like. By being provided with an antenna receiving airwaves or a tuner, the display device 700 can also be used as a television device.

As the display portion 702, a semiconductor display device such as a liquid crystal display device, a light-emitting device in which a light-emitting element such as an organic EL element is provided in each pixel, an electrophoresis display device, a digital micromirror device (DMD), a plasma display panel (PDP), a field emission display (FED), or the like can be used.

As the power storage device 703, the power storage device described in any of the above embodiments can be used. Since the energy density of the power storage device described in the above embodiment is high, the display device 700 can operate for a long time even in a state of not being supplied with power externally. The power storage device 703 may be provided inside the housing 701; alternatively, the power storage device 703 may be provided outside the housing 701. The display device 700 can use either power supplied externally (from a commercial power supply) or power stored in the power storage device 703. Therefore, even when external power supply is stopped due to a power failure or the like, the display device 700 can operate with the use of power stored in the power storage device 703.

The following method of using the power storage device 703 can also be used: in a time period of midnight power service, power is stored in the power storage device 703 while the display device 700 operates with the use of power supplied from the outside; and during daytime hours, the display device 700 operates with the use of the power stored in the power storage device 703. By employing such a method, low-cost midnight power can be efficiently utilized, so that those who use the device have an advantage of low electricity charges and electric power providers have an advantage of leveling the amount of power supply.

The power storage device according to one embodiment of the present invention can be mounted not only in a monitor of a desktop personal computer or a television device, but also in a variety of display devices such as a monitor of a laptop personal computer and an advertisement display board.

In FIG. 7A, a lighting device 710 includes housings 711, light sources 712, power storage devices 713, and the like. The power storage devices 713 are each provided inside the housings 711. The lighting device 710 can use either power supplied externally or power stored in the power storage devices 713. As the power storage devices 713, the power storage device described in any of the above embodiments can be used. Since the energy density of the power storage device described in the above embodiment is high, the lighting device 710 can operate for a long time even in a state of not being supplied with power externally. Similarly to the display device 700, the lighting device 710 has advantages in that it can be used even in an emergency such as a power failure, it provides low electricity charges, and it enables the amount of power supply to be leveled.

Although the lighting device 710 embedded in the ceiling is illustrated in FIG. 7A, a lighting device using the power storage device according to one embodiment of the present invention can be installed on a wall, a floor, a window, or the like. Alternatively, the power storage device can be used for a tabletop lighting device and the like.

As the light source 712, an artificial light source can be used. Specific examples of the artificial light source include discharge lamps such as an incandescent lamp and a fluorescent lamp, and light-emitting elements such as an LED and an organic EL element.

In FIG. 7A, an air conditioner 720 includes a housing 721 (also referred to as indoor air-conditioning equipment), an air outlet 722, a power storage device 723, and the like. As the power storage device 723, the power storage device described in any of the above embodiments can be used. Since the energy density of the power storage device described in the above embodiment is high, the air conditioner 720 can operate for a long time even in a state of not being supplied with power externally. Although FIG. 7A illustrates the case where the power storage device 723 is provided in the housing 721, one embodiment of the present invention is not limited thereto; alternatively, the power storage device 723 may be provided in an outdoor air-conditioning equipment (not illustrated). Still alternatively, the power storage device 723 may be provided in each of the housing 721 and the outdoor air-conditioning equipment (not illustrated). The air conditioner in FIG. 7A can use either power supplied externally or power stored in the power storage device 723. Similarly to the display device 700, the air conditioner 720 has advantages in that it can be used even in an emergency such as a power failure, it provides low electricity charges, and it enables the amount of power supply to be leveled.

Note that although the split-type air conditioner including the indoor air-conditioning equipment and the outdoor air-conditioning equipment is described above, the power storage device according to one embodiment of the invention can be used in an air conditioner in which the functions of an indoor unit and an outdoor unit are integrated in one housing.

In FIG. 7A, an electric refrigerator-freezer 730 includes a housing 731, a door for a refrigerator 732, a door for a freezer 733, a door for a vegetable drawer 734, a power storage device 735, and the like. As the power storage device 735, the power storage device described in any of the above embodiments can be used. Since the energy density of the power storage device described in the above embodiment is high, the electric refrigerator-freezer 730 can operate for a long time even in a state of not being supplied with power externally. The power storage device 735 is provided in the housing 731. The electric refrigerator-freezer 730 can use either power supplied externally or power stored in the power storage device 735. Thus, the electric refrigerator-freezer 730 can operate with the use of the power storage device according to one embodiment of the invention as the power storage device 735 even when external supply of power is stopped due to a power failure or the like. Similarly to the display device 700, the electric refrigerator-freezer 730 has advantages in that it can be used even in an emergency such as a power failure, it provides low electricity charges, and it enables the amount of power supply to be leveled.

In FIG. 7A, a power storage device 740 is a large-sized power storage device, and the above products can be supplied with power from the power storage device 740. By supplying power to a plurality of products from one power storage device in this manner, in the case of a power failure or the like, power can be assigned depending on the frequency of use of each device in such a manner that, for example, power supply to a device which is less frequently used is stopped and power supply to a device which is frequently used is performed intensively. In this manner, a device which is frequently used can operate for a long time.

In FIG. 7B, an electric vehicle 750 is equipped with a power storage device 751. The output of power of the power storage device 751 is controlled by a control circuit 752 and the power is supplied to a driving device 753. The control circuit 752 is controlled by a computer 754. As the power storage device 751, the power storage device described in any of the above embodiments can be used. Since the energy density of the power storage device described in the above embodiment is high, the electric vehicle 750 can operate for a long time even in a state of not being supplied with power externally.

The driving device 753 includes a DC motor or an AC motor either alone or in combination with an internal-combustion engine. The computer 754 outputs a control signal to the control circuit 752 based on input data such as data of a driver's operation (e.g., acceleration, deceleration, or stop) of the electric vehicle 750 or data in driving the electric vehicle 750 (e.g., data of an upgrade or a downgrade or data of a load on a driving wheel). The control circuit 752 adjusts electric energy supplied from the power storage device 751 in response to the control signal of the computer 754 to control the output of the driving device 753. In the case where the AC motor is mounted, an inverter which converts direct current into alternate current is also incorporated.

The power storage device 751 can be charged by external power supply using a plug-in system. When the power storage device according to an embodiment of the present invention is provided as the power storage device 751, a shorter charging time and improved convenience can be achieved. Besides, the higher charging and discharging rate of the power storage device can contribute to greater acceleration and excellent characteristics of the electric vehicle. When the power storage device 751 itself can be formed to be compact and lightweight as a result of improved characteristics of the power storage device 751, the vehicle can be lightweight and fuel efficiency can be increased.

### Example 1

In this example, the shape of whiskers that are used as the second current collector in any of the above embodiments and a method of forming the whiskers will be described with reference to actual experimental results. Note that in this example, in order to clearly show the shape of the whiskers, the experiment was carried out with the use of a titanium sheet as the first current collector instead of the porous or mesh material used in the above embodiment.

First, a sheet of a titanium film (also referred to as titanium sheet) with a purity of 99.5% and a thickness of 100 μm was introduced into a (quartz) reaction chamber of an LPCVD apparatus, and a silane gas with a flow rate of 300 sccm and a nitrogen gas with a flow rate of 300 sccm were introduced into the reaction chamber in which the temperature was kept at 550° C. and the pressure was set to 150 Pa. In such a manner, a second current collector was formed over the titanium film by an LPCVD method. Note that when the temperature was increased, a small amount of helium gas was introduced into the reaction chamber.

Then, the temperature in the reaction chamber was decreased, and the titanium sheet was taken out.

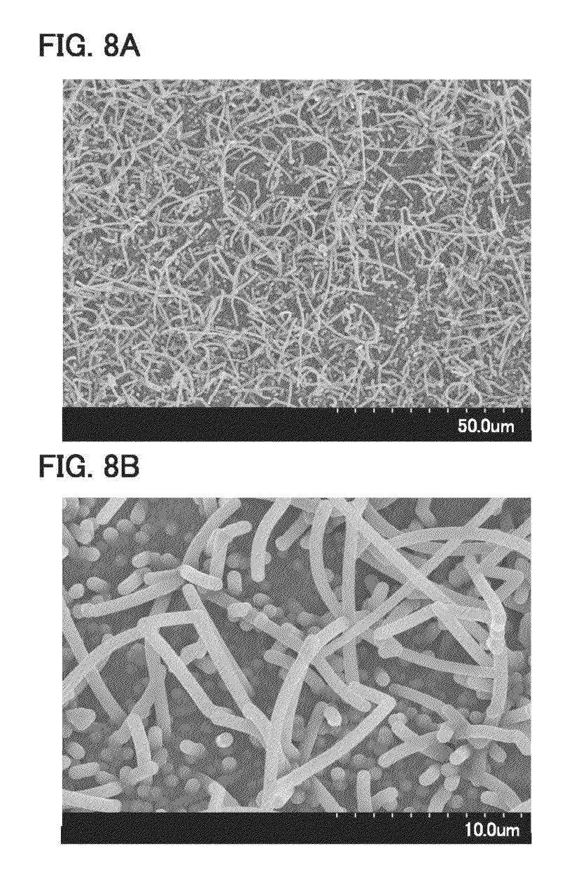

FIGS. 8A and 8B are planar scanning electron microscope (SEM) images of a surface of the electrode of the example battery, which was obtained through the above process. Note that the image in FIG. 8A was taken at a magnification of ×1000, and the image in FIG. 8B was taken at a magnification of ×5000.

As shown in FIGS. 8A and 8B, a plurality of whiskers was formed on the surface of the titanium sheet. This shows that formation of a catalyst layer on whiskers enables the surface area of the catalyst layer to be significantly large. Note that the length of the long whiskers along the axis thereof was about 80 μm to 100 μm. The width of a cross section of the whiskers was 0.7 μm to 1.0 μm. Some of the whiskers were curved toward their tips.

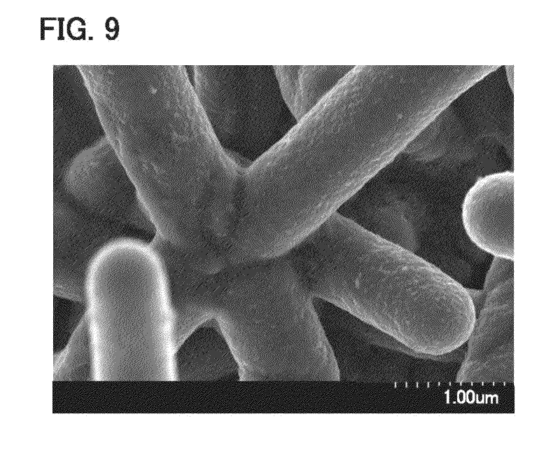

FIG. 9 shows an enlarged image of part of the whiskers formed on the surface of the titanium sheet. The image in FIG. 9 was taken at a magnification of ×300000.

As shown in FIG. 9, a plurality of minute projections is provided on the surfaces of the whiskers. These projections seem to have a net-like shape on the surfaces of the whiskers. Note that the projections have a height of approximately 5 nm to 50 nm.

### Example 2

In this example, a sample in which a graphene film is formed on a surface of whisker-like silicon by an electrophoresis method (hereinafter, this sample is referred to as Sample A) will be described.

First, an aqueous solution in which graphene oxide is dispersed is produced. An aqueous solution in which graphene oxide is dispersed was produced as described below. Potassium permanganate was added to a mixture of graphite (flake carbon) and concentrated sulfuric acid, followed by stirring for 2 hours. After that, pure water was added to the mixture, the mixture was stirred for 15 minutes while being heated, and a hydrogen peroxide solution was added thereto, so that a yellow-brown solution containing graphite oxide was obtained. Furthermore, the obtained solution was filtered, and hydrochloric acid was added, followed by washing with pure water. After that, ultrasonic treatment was performed for 2 hours so that the graphite oxide was changed into graphene oxide, and an aqueous solution in which graphene oxide was dispersed was obtained.

The titanium sheet with the whisker-like silicon in the above example was immersed in the aqueous solution, and a stainless steel plate was immersed therein as an electrode. The distance between the titanium sheet and the stainless steel plate was 1 cm. Then, with the titanium sheet used as an anode and the stainless steel plate used as a cathode, a voltage of 10 V was applied between the anode and the cathode for 5 minutes. The amount of charge flowing during the 5 minutes was 0.114 C. A schematic view of this apparatus is illustrated in FIG. 5.

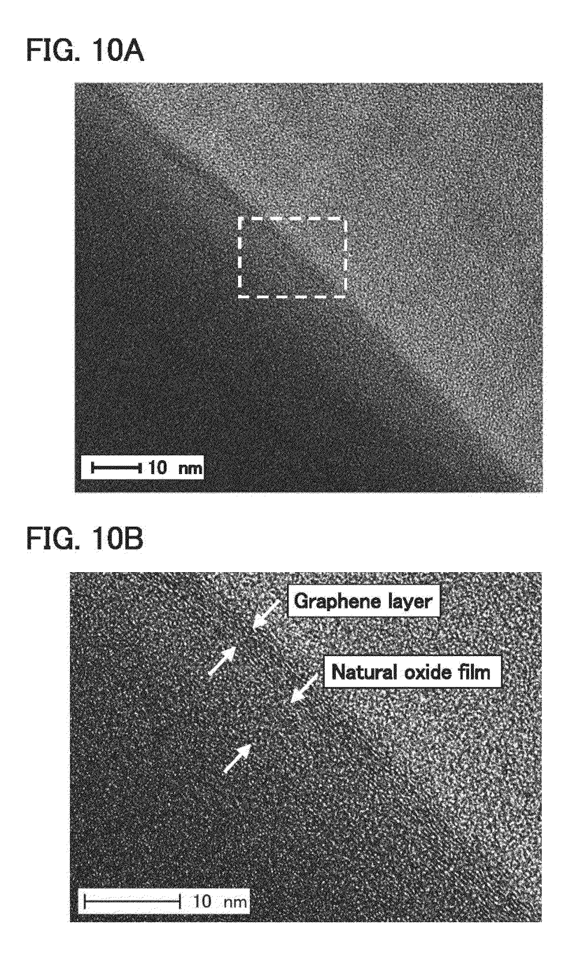

After that, the titanium sheet was taken out of the solution, dried, and then heated at 300° C. in a vacuum (0.1 Pa or less) for 10 hours. In such a manner, Sample A was produced. FIGS. 10A and 10B show cross-sectional transmission electron microscope (TEM) images of the obtained whisker-like silicon. The image in FIG. 10A was taken at a magnification of ×2050000. The image in FIG. 10B is an enlarged view of a portion surrounded by a dotted line in FIG. 10A.

As shown in FIGS. 10A and 10B, a graphene layer with a thickness of approximately 2 nm to 3 nm was formed on a natural oxide film with a thickness of 2 nm to 3 nm on a surface of the whisker-like silicon.

Peaks of a D band and a G band, which are characteristics of graphene, were seen in any portion of the whiskers in measurements by Raman spectroscopy. This shows that substantially the entire surfaces of the whiskers are most probably covered with graphene.

In the case of employing a coating method, the thickness of a graphene layer largely varies among samples, or varies from region to region in the sample; thus, the thickness of a graphene layer is difficult to control. In contrast, in the case of the electrophoresis method, the thickness of the graphene layer can be controlled with the amount of charge; thus, the electrophoresis method has extremely high reproducibility. As described above, the graphene layer formed by the electrophoresis method described in Embodiment 1 can be extremely uniform.

This application is based on Japanese Patent Application serial no. 2011-189289 filed with Japan Patent Office on Aug. 31, 2011, the entire contents of which are hereby incorporated by reference.

What is claimed is:

1. A power storage device comprising:
a metal anode;
an air electrode; and
an electrolyte solution between the metal anode and the air electrode,
wherein the air electrode comprises:
a first current collector;
a second current collector having a projecting structure, in contact with the first current collector; and
a catalyst layer on the second current collector,
wherein the catalyst layer comprises at least one graphene film.

2. The power storage device according to claim 1, wherein the catalyst layer comprises 1 or more and 100 or less graphene films.

3. The power storage device according to claim 1,
wherein the metal anode comprises aluminum, zinc, or iron, and
wherein the electrolyte solution is an aqueous electrolyte solution.

4. The power storage device according to claim 1,
wherein the metal anode comprises lithium, calcium, sodium, or magnesium, and
wherein the electrolyte solution is an organic electrolyte solution.

5. The power storage device according to claim 1, wherein the first current collector is a porous or mesh conductive material.

6. The power storage device according to claim 1, wherein the projecting structure of the second current collector is a plurality of whiskers comprising silicon.

7. The power storage device according to claim 6, further comprising a plurality of projections each having a height of 100 nm or less on surfaces of the plurality of whiskers.

8. A power storage device comprising:
a metal anode comprising lithium;
an air electrode;
a solid electrolyte between the metal anode and the air electrode;
an organic electrolyte solution between the metal anode and the solid electrolyte; and
an aqueous electrolyte solution between the air electrode and the solid electrolyte,
wherein the solid electrolyte selectively transmits only a lithium ion, and
wherein the air electrode comprises:
a first current collector;
a second current collector having a projecting structure, in contact with the first current collector; and
a catalyst layer on the second current collector,
wherein the catalyst layer comprises at least one graphene film.

9. The power storage device according to claim 8, wherein the catalyst layer comprises 1 or more and 100 or less graphene films.

10. The power storage device according to claim 8, wherein the first current collector is a porous or mesh conductive material.

11. The power storage device according to claim 8, wherein the projecting structure of the second current collector is a plurality of whiskers comprising silicon.

12. The power storage device according to claim 11, further comprising a plurality of projections each having a height of 100 nm or less on surfaces of the plurality of whiskers.

13. A method of manufacturing a power storage device, comprising the steps of:
forming a first current collector;
forming a second current collector having a projecting structure over the first current collector; and
forming a catalyst layer comprising at least one graphene film, on the second current collector,
wherein the catalyst layer is formed by a method comprising the steps of:
immersing an object comprising the first current collector and the second current collector having the projecting structure and an electrode in a solution including graphene oxide;
applying voltage between the object and the electrode in the solution to form a graphene oxide layer over the object; and
heating the object in a vacuum or in a reducing atmosphere so that the graphene oxide layer formed over the object is reduced to graphene,
wherein the first current collector and the second current collector having the projecting structure are an air electrode, and
wherein the air electrode is used as an electrode of the power storage device.

14. The method of manufacturing a power storage device according to claim 13, wherein the catalyst layer comprises 1 or more and 100 or less graphene films.

15. The method of manufacturing a power storage device according to claim 13, wherein the first current collector is a porous or mesh conductive material.

16. The method of manufacturing a power storage device according to claim 13, wherein the projecting structure of the second current collector is a plurality of whiskers comprising silicon.

17. The method of manufacturing a power storage device according to claim 16, wherein the plurality of whiskers comprises a plurality of projections each having a height of 100 nm or less on its surface.
